(19) United States
(12) Patent Application Publication
(10) Pub. No.: US 2025/0327940 A1
(43) Pub. Date: Oct. 23, 2025

(54) METHOD FOR PROCESSING A DETECTOR SIGNAL, DETECTION MODULE AND SORTING MACHINE

(71) Applicant: KETEK GmbH Halbleiter- und Reinraumtechnik, Muenchen (DE)

(72) Inventors: Peter Iskra, Neubiberg (DE); Werner Buttler, Essen (DE); Florian Wiest, Muenchen (DE)

(21) Appl. No.: 18/642,373

(22) Filed: Apr. 22, 2024

(51) Int. Cl. G01T 1/24; B07C 5/342; G01T 1/17

(52) U.S. Cl. CPC G01T 1/247; B07C 5/3427; G01T 1/17; G01T 1/244

(57) ABSTRACT

Embodiments provide a method for processing a detector signal, which comprises a sequence of signal peaks. The method comprises a digitization step and a transferring step. In the digitization step, the detector signal is processed and binned in at least one region of interest depending on an area of the signal peaks. At least one number of counts is determined by a counter in the digitization step, wherein the number of counts corresponds to the number of signal peaks in the region of interest. In the transferring step, the number of counts is provided as an output signal. During the digitization step, the method is free of a clock signal.

### TECHNICAL FIELD

A method for processing a detector signal is specified. Furthermore, a detection module and a sorting machine are specified.

### SUMMARY

Embodiments provide an improved method for processing a detector signal that in particular enables a reduction of noise during processing. Further embodiments provide an improved detection module and an improved sorting machine that enable the improved method to be carried out.

According to at least one embodiment, the method for processing a detector signal comprises a detector signal with a sequence of signal peaks. In particular, the detector signal is provided by a detector unit comprising at least one detector. For example, the detector is a semiconductor component. In particular, the detector is configured to detect electromagnetic radiation, preferably X-rays. For example, the detector is a silicon drift detector. In particular, the signal peaks correspond to incident electromagnetic radiation on the detector. Thereby, a height of the signal peaks and/or preferably an area of the signal peaks may be associated with a photon energy of the electromagnetic radiation. For example, the height, more specific the area of each signal peak corresponds to a charge that is generated when detecting the photon and forming the signal peak. In particular, photons with a higher energy generate more charges than photons with a lower energy during a detection event. Consequently, higher energy photons generate a higher and broader signal peak, in general a signal peak with a larger area. In particular, each signal peak corresponds to one photon detected by the detector and the height and/or area of this signal peak corresponds to the energy of the photon.

According to at least one embodiment, the method for processing a detector signal comprises a digitization step and a transferring step. In particular, the digitization step and the transferring step are distinct. That is, the digitization step and the transferring step are carried out independently and separately from each other. For example, the transferring step is carried out after the digitization step is terminated.

According to at least one embodiment of the method for processing a detector signal, the detector signal is processed and binned in at least one region of interest, depending on an area of the signal peaks in the digitization step. For example, the detector signal is processed such that the signal peaks can be binned in at least one region of interest. In particular, the detector signal is processed such that the area of the signal peaks can easily be distinguished from each other so that the detector signal can be binned depending on the area of the signal peaks.

Each region of interest comprises, for example, an upper interest level and optionally a lower interest level defining the region of interest. If an area of a corresponding signal peak is below the upper interest level, a counter associated with upper interest level is increased. By subtracting the counter associated to two different lower interest levels, the number of counts in a region of interest defined by the two different lower interest levels can be determined.

Alternatively, if a region of interest is defined by a lower interest level and an upper interest level and an area of a corresponding signal peak is between the lower interest level and the upper interest level, the certain signal peak is assigned to the region of interest corresponding to the lower interest level and the upper interest level.

According to at least one embodiment of the method for processing a detector signal, at least one number of counts is determined by a counter unit in the digitization step. The number of counts corresponds to the number of signal peaks in the region of interest. That is, each time a certain signal peak is binned in a specific region of interest, the number of columns corresponding to the specific region of interest is increased. In particular, in the digitization step the sequence of signal peaks is processed to at least one number of counts corresponding to at least one region of interest. This means, in particular, that the number of signal peaks with a certain area, i.e. a certain associated photon energy, corresponding to the at least one region of interest can be evaluated.

According to at least one embodiment of the method for processing a detector signal, the number of counts is provided as an output signal during the transferring step. In particular, the output signal is exclusively provided during the transferring step. The output signal is, for example, a sequence of numbers, indicating the number of counts for each region of interest. If there is, for example, only one region of interest, the output signal may comprise only the number of counts assigned to this region of interest. If there are, for example, two, three or more regions of interest, the output signal may comprise one, two or more number of counts, respectively assigned to the regions of interest.

According to at least one embodiment, the method for processing a detector signal is free of a clock signal in the digitization step. That is, no clock signal or clock is provided during the digitization step. However, a clock signal may be provided in the transferring step, for example for transmission of the output signal.

In at least one embodiment, the method for processing a detector signal, which comprises a sequence of signal peaks, comprises a digitization step and a transferring step. In the digitization step, the detector signal is processed and binned in at least one region of interest, depending on the area of the signal peaks. At least one number of counts is determined by a counter unit in the digitization step, wherein the number of counts corresponds to the number of signal peaks in the region of interest. In the transferring step, the number of counts is provided as an output signal. During the digitization step, the method is free of a clock signal.

The method described here is based on the following technical considerations. Methods for reading and processing detector signals typically comprise a digitization of the signal for further evaluation. Since digital signals can usually be processed and transmitted with reduced noise, it is desired to move an analogue-digital-interface comparably close to the detector itself. However, common analogue-digital-conversion commonly requires a clock signal to convert the analogue signal from the detector to a digital output. Especially in applications where there are relatively few detection events and a comparably low signal is produced by the detector, such a clock signal may interfere with the detection signal, resulting in a poor signal-to-noise ratio for the detector signal.

One example for such an application is the detection of X-ray photons by a silicon drift detector. Thereby, the silicon drift detector produces current pulses comprising about 10 to 100,000 electrons, depending on the energy of the photon. The output of a charge-sensitive amplifier connected to the detector is an integrated signal with a plurality of steps from the current pulses, wherein the step height of each of the steps corresponds to the energy of the photon. Typically, the charge-sensitive amplifier and the silicon drift detector form one detector component. Due to small step heights, the integrated signal is prone to noise, in particular at certain frequency bands, like from 1 Hz to 100 MHz. To avoid noise and cross talk on the integrated signal, there are no digital signals, and in particular no clock signals, provided in the detector component. Therefore, digitization has to take place outside the detector component, for example in a preamplifier or at an input of a digital pulse processor, which is configured to extract a spectrum from the integrated signal.

The method described herein makes use of the idea of processing and binning the detector signal in regions of interest without providing a clock signal. Once the detector signal is digitized in the digitization step, a clock signal is provided to transfer the number of counts for each region of interest as the output signal. In the transferring step, however, processing of the detector signal is preferably stopped. Consequently, the clock signal does not interfere with the detector signal. In turn, digitization of the detector signal can be moved closer to the detector unit, which makes processing of the detector signal easier and more robust with respect to noise.

Furthermore, by defining at least one region of interest, the amount of data to be output can be limited. For example, if only a small number of regions of interest is desired, for example 4 or 8 or 16 or 32 or 64 regions of interest, only a correspondingly small number of counts corresponding to the regions of interest has to be transferred as the output signal. This contrasts with conventional processing of the detector signal by means of a digital pulse processor, where significantly more data is required to reproduce a whole spectrum.

However, for many applications, such as ore sorting based on X-ray fluorescence (XRF), only certain characteristic X-ray peaks are of interest. These X-ray peaks may correspond to certain materials or material compositions, whose presence in a sample is of interest, for example. It is thus sufficient to define regions of interest representing these characteristic X-ray peaks and counting the number of detector peaks associated with these regions of interest to determine whether the material or material composition of interest is included in the sample. It is therefore not necessary to provide the complete fluorescence spectrum for the analysis, which reduces the amount of data to be processed and saves computation time.

According to at least one embodiment of the method for processing a detector signal, the clock signal is provided exclusively during the transferring step.

According to at least one embodiment of the method of processing a detector signal, a reset signal is provided in the transferring step such that the counter unit is terminated, and the output signal is provided during provision of the reset signal. In particular, provision of the reset signal starts the transferring step. The transferring step, in particular, is carried out as long as the reset signal is provided. If the reset signal is not provided, the digitization step is preferably carried out.

In particular, when the reset signal is provided, the clock signal is also provided. Advantageously, the counter unit is terminated if the reset signal is provided, so that counting of the binned detector signal is carried out exclusively if no clock signal is provided. Therefore, noise during the digitization step can be reduced.

According to at least one embodiment of the method for processing a detector signal, the detector signal is integrated by an integration unit in the digitization step. For example, the detector signal is processed to an integrated signal that may be a continuous ramped signal with several step events. The detector signal preferably comprises a plurality of steps, wherein each step corresponds to the height and/or preferably area of an associated signal peak of the detector signal. For example, the integration unit is a charge-sensitive amplifier.

According to at least one embodiment of the method for processing a detector signal, the integration unit is reset in the transferring step such that a cumulated signal, at the input of the integration unit is zero or essentially zero. The cumulated signal emerges from a cumulated charge at the input, for example. The reset of the integration unit is triggered, for example, by the reset signal.

The integration unit preferably comprises an input transistor at the input. The charge of the signal pulses of the detector signal or signals are cumulated in the integration unit, which may be an amplifier, in order to generate the integrated signal as an output signal of the integration unit. If a signal, which for example represents a charge, is cumulated at the input of the integration unit such that the integration unit leaves its operation range, the integration unit must be reset.

In particular, the reset signal is a digital signal, wherein a specific reset signal value resets the integration unit. The specific reset signal value may be “1” or “0” or any other appropriate and uniquely value, depending on the reset signal. Furthermore, the transferring step is carried out as long as the reset signal value is provided.

In particular, resetting the integration unit takes about 0.05 μs to 10 μs. Transferring the output signal takes, depending on the number of evaluated regions of interests and maximum counter values, from about 0.05 μs up to 100 μs. Hence, transferring the output signal takes about a factor of 0.1 to 104 longer than resetting the integration.

According to at least one embodiment of the method for processing a detector signal, the detector signal is processed to the integrated signal by integrating the detector signal by means of an integration unit in the digitization step. That is in particular, the digitalization step is a phase of the method, in which a measurement is carried out. In particular, after the integration unit, the detector signal is processed to the integrated signal, which may be a continuous ramped signal with several step events.

According to at least one embodiment of the method for processing a detector signal, the integrated signal is processed to a shaped signal comprising a plurality of shaped peaks by means of a shaping unit in the digitization step. For example, the integrated signal, which may be a continuous ramped signal, is processed by the shaping unit to the shaped signal. The shape signal in particular comprises a sequence of shaped peaks.

The shaped peaks are preferably Gaussian or essentially Gaussian or quasi-Gaussian. In particular, each shaped peak corresponds to a step of the integrated signal. For example, the height of each shaped peak corresponds to the height of the corresponding step of the integrated signal. That is, the initial detector signal may be processed at the shaping unit to the shape signal, which comprises a plurality of shaped peaks, wherein consequently the height of each shaped peak corresponds to the area of the corresponding signal peak.

According to at least one embodiment of the method for processing a detector signal, the shape signal is binned in at least one region of interest depending on the height of the shaped peaks in the digitization step. The binning is carried out by comparing the height of each shaped peak to at least one upper interest level and optionally to at least one lower interest level by a comparator unit. The comparator unit may also be referred to as discriminator unit.

The comparator unit preferably comprises at least one comparator associated with each upper interest level. If a height of the shaped peak is lower than one specific upper interest level, the corresponding shaped peak is assigned to this upper interest level. The number of peaks assigned to a certain upper interest level may be compared to, in particular subtracted from the number of peaks assigned to at least one other upper interest level. For example, the other upper interest level is lower than the certain interest level. The certain upper interest level and the other upper interest level thereby define a region of interest. This allows that the number of peaks, whose heights are between the certain upper interest level and the other interest level can be binned in the region of interest defined by these levels. In this way, binning of the shaped peaks in N region of interests with N comparators is possible. However, subtracting the number of peaks associated with each upper interest level is necessary.

In case that a lower and upper interest level are present, the lower interest level and the upper interest level define the region of interest. For example, the comparator unit comprises at least two comparators, wherein at least one comparator compares the shaped peaks to the at least one lower interest level and at least one comparator compares the shaped peaks to the at least one upper interest level. If the height of a shaped peak is above the lower interest level and below the upper interest level, this peak is binned in the region of interest corresponding to this lower interest level and this upper interest level. If there is more than one region of interest, this procedure is preferably carried out for every region of interest. In particular, the comparator unit comprises two comparators for every region of interest present. Such a comparator unit is also referred to as a window comparator. In this way, binning of the shaped peaks in N region of interests with 2N comparators is possible. However, compared to the previously described solution, a larger number of comparators is necessary.

According to at least one embodiment of the method for processing a detector signal, the counter unit increases the number of columns corresponding to the region of interest for every shaped peak whose height is in the region of interest. In particular, the counter unit increases the number of counts corresponding to a certain region of interest for every shaped peak of the shaped signal that is binned into this certain region of interest.

The number of counts or the sequence of number of counts may be provided as the output signal. Such an output signal is a digital signal. Hence, the detector signal is digitized without usage of a clock signal.

According to at least one embodiment of the method for processing a detector signal, the integrated signal comprises a plurality of steps, wherein each step corresponds to a signal peak or the detection signal. In particular, each step corresponds to the area of the corresponding signal peak. In particular, the integrated signal is a continuous ramped signal with several step events, wherein the value of the signal increases with every step and remains essentially constant to the next step.

The height of each step corresponds in particular to the energy of a photon that is detected by the detector unit. For example, the photon generates a signal peak in the detector signal. The area of the signal peak in particular corresponds to the energy of the photon. Consequently, the height of the step, which corresponds to the area of the signal peak, corresponds to the energy of the photon.

According to at least one embodiment of the method for processing a detector signal, the reset signal is provided for a reset time. The reset time is determined by a period for resetting the integration unit or by a period for providing the output signal. In particular, the reset time is determined by either the period for resetting the integration unit or by the period for providing the output signal, whichever is longer. For example, if the period for resetting the integration unit is shorter than the period for transferring the output signal, the reset time is determined by the period for transferring the output signal. In another example, if the period for resetting the integration unit is longer than the period for transferring the output signal, the reset time is determined by the period for resetting the integration unit.

In particular, the reset time determines how long the transferring step is carried out. For example, the reset time determines how long the clock signal is provided. By determining the reset time by the longer one of the period for resetting the integration unit and the period for providing the output, it can be ensured that providing the output signal and resetting the integration unit can be carried out completely in the transferring step.

According to at least one embodiment of the method for processing a detector signal, the reset signal comprises at least one reset pulse. The reset pulse is, for example, a rectangular pulse. Preferably, the reset signal comprises exactly one reset pulse. The reset pulse may determine the specific reset signal value of the reset signal. The reset pulse may further determine the reset time. It is possible that the reset signal essentially only comprises the reset pulse and the reset signal is essentially only provided during the reset pulse.

According to at least one embodiment of the method for processing a detector signal, the reset pulse comprises a rising edge and a falling edge. The rising edge or falling edge terminates the counter unit and activates the resetting of the integration unit. The falling edge or rising edge activates the counter unit and terminates the resetting of the integration unit. This means in particular that the rising/falling edge starts the transferring step and ends the digitization step. Analogously the digitization step may be started by the falling/rising edge and the transferring step may be ended by the falling/rising edge. Furthermore, providing the output signal and the clock signal may be initiated with the rising/falling edge and ended with the falling/rising edge.

According to at least one embodiment of the method for processing a detector signal, the detector signal is provided by at least one silicon drift detector. The silicon drift detector is preferably configured to detect X-rays. In particular, the silicon drift detector is configured to detect X-ray photons and provide the detector signal as a sequence of peaks, wherein each peak corresponds to an X-ray photon. For example, the area of each peak corresponds to the energy of the associated X-ray photon.

Furthermore, a detection module is specified. In particular, the detection module is configured to carry out a method for processing a detector signal according to one or more embodiments described herein. That is, all features disclosed for the method for processing a detector signal are also disclosed for the detection module and vice versa.

According to at least one embodiment the detection module comprises an evaluation unit. For example, the evaluation unit is configured to carry out the method for processing a detector signal in accordance with one or more embodiments thereof described herein.

According to at least one embodiment of the detection module, the evaluation unit comprises an integration unit configured to process a detection signal, comprising a plurality of signal peaks, to an integrated signal by integrating the detection signal. For example, an input of the integration unit is connected to an output where the detection signal is provided. The integration unit is, for example, a charge-sensitive amplifier.

According to at least one embodiment of the detection module, the evaluation unit comprises a shaping unit configured to process the integrated signal into a shaped signal comprising a plurality of shaped peaks. For example, an input of the shaping unit is connected to an output of the integration unit.

According to at least one embodiment of the detection module, the evaluation unit comprises a comparator unit configured to compare a height of each shaped peak to at least two upper interest levels. If the height of a certain shaped peak is below an upper interest level, the shaped peak is assigned to this upper interest level. A region between the two upper interest level defines the region of interest. For example, by subtracting the peaks of a first upper interest level from the peaks of a second upper interest level, gives the peaks assigned to the region of interest.

For example, if N regions of interest are defined, N upper interest levels are defined. That is, the comparator unit comprises N comparators, each assigned with one upper interest level. The comparator unit may be thus configured to compare the height of each shaped peak to N upper interest levels, which define N regions of interest. A comparator unit according to this embodiment consequently allows a binning of the shaped peaks in N regions of interests by using N comparators.

According to at least one embodiment of the detection module, the evaluation unit comprises a comparator unit configured to compare a height of each shaped peak to at least one lower interest level and at least one upper interest level defining at least one region of interest. If the height of a certain shaped peak is above the lower interest level and below the upper interest level, this shaped peak is binned in the region of interest. For example, the comparator unit comprises 2N comparators, wherein N comparators are configured to compare the shaped peaks to N corresponding lower interest levels and the other N comparators are configured to compare the shaped peaks to N corresponding upper interest levels. In this example, there are N regions of interest. Preferably, N is a natural number greater than or equal to one. In particular, an input of the comparator unit is connected to an output of the shaping unit. Such a comparator unit is also referred to as a window comparator.

According to at least one embodiment of the detection module, the evaluation unit comprises a counter unit configured to increase the number of counts corresponding to the region of interest for every shaped peak whose height is in the region of interest. In other words, the counter unit is configured to increase the number of counts of each region of interest if a shaped peak is binned in the region of interest. For example, the counter unit comprises a plurality of counters, wherein each counter is uniquely connected to one pair of comparators of the comparator unit. A pair of comparators is formed, for example, by a comparator for a lower interest level and a comparator for an upper interest level which together define one region of interest. That is, an input of the counter unit is preferably connected to an output of the comparator unit.

According to at least one embodiment of the detection module, the evaluation unit comprises a storage unit configured to store the number of counts of the region of interest. If there is more than one region of interest, the storage unit is preferably configured to store each number of counts corresponding to each region of interest. For example, the storage unit may comprise one or more shift registers. In particular, the storage unit is connected to an output of the counter unit.

According to at least one embodiment of the detection module, the evaluation unit comprises an output unit configured to output the number of counts as an output signal. If there is more than one region of interest and hence more than one number of counts, the output signal preferably comprises a sequence of the number of counts. In particular, the output signal is a digital signal. Preferably, the output unit is connected to the storage unit.

In at least one embodiment the detector module comprises an evaluation unit. The evaluation unit comprises an integration unit configured to process a detection signal comprising a plurality of signal peaks to an integrated signal by integrating the detection signal. The evaluation unit further comprises a shaping unit configured to process the integrated signal to a shaped signal comprising a plurality of shaped peaks. The evaluation unit further comprises a comparator unit configured to compare a height of each of the shaped peaks to at least one lower interest level and at least one upper interest level defining at least one region of interest. Furthermore, the evaluation unit comprises a counter unit configured to increase the number of counts corresponding to the region of interest for every shaped peak whose height is in the region of interest. The evaluation unit further comprises a storage unit configured to store the number of counts of the region of interest. The evaluation unit comprises an output unit configured to output the number of counts as an output signal.

According to at least one embodiment of the detection module, the detection module, in particular the evaluation module, further comprises a reset logic configured check both if the reset of the integration unit is complete and if the transferring step is complete. That is, the reset logic monitors if in the transferring step, providing of the output signal and resetting the integration unit are fully carried out.

According to at least one embodiment of the detection module, the detection module, in particular the evaluation module, further comprises a reset logic configured to provide a reset signal and a clock signal. When the reset signal is provided during operation, the integration unit is configured to be reset and the output unit is configured to provide the output signal. Furthermore, when the reset signal is provided, the counter unit is configured to terminate the number of counts and the reset logic is configured to exclusively provide the clock signal. In other words, the reset logic switches between the digitization step and the transferring step by providing the reset signal.

According to at least one embodiment of the detection module, the integration unit and the shaping unit are arranged on a first electronic chip and the counter unit and the storage unit, and optionally the reset logic, are arranged on a second electronic chip distinct from the first electronic chip. For example, each of the electronic chips is an application specific integrated circuit (ASIC). By forming the evaluation unit on two distinct chips, a suitable chip architecture can be adapted for each of the components of the evaluation unit. For example, the integration unit and the shaping unit, in particular all units and components on the first electronic chip, can be formed with 350 nm technology. The comparator unit, the counter unit and the storage unit and optionally the reset logic, in particular all units and components on the second electronic chip, may be formed with 150 nm technology. In particular, the first and/or second electronic chip may be formed by CMOS technology.

According to at least one embodiment of the detection module, at least the integration unit, the shaping unit, the comparator unit, the counter unit and the storage unit are arranged on a common electronic chip. Preferably, the reset logic is also arranged on the common electronic chip. The common electronic chip is preferably an ASIC. By forming all components of the detection module or the evaluation module on a common electronic chip, the detection module can be formed to be particularly compact. In particular, the common electronic chip may be formed by CMOS technology.

According to at least one embodiment of the detection module, the detection module further comprises a detector unit configured to generate the detector signal from detected electromagnetic radiation. The detector unit preferably comprises at least one silicon drift detector.

The detector unit is in particular configured to detect X-rays. For example, the detector unit or the silicon drift detector is configured to detect X-ray photons, in particular individual X-ray photons. For example, each signal peak of the detector signal corresponds to one detected X-ray photon. In particular, the detector unit or the silicon drift detector is configured to generate a current pulse comprising about 10 to about 100,000 electrons, depending on the energy of the X-ray photon. Each of these current pulses represents one signal peak in the detector signal. Hence, the area of each signal peak corresponds to the energy of an associated detected X-ray photon.

The detector unit is arranged, for example, on the first electronic chip or on the common electronic chip. It is also possible that the detector unit is arranged on an individual detector chip or in an electronic package. The detector chip or package is preferably a semiconductor chip or package comprising at least one semiconductor detector. The semiconductor detector may be a silicon drift detector such that the detector chip may comprise at least one silicon drift detector.

According to at least one embodiment of the detection module, the detection module further comprises a process unit configured to process the output signal. Furthermore, the process unit is in particular configured to control the detection module. Preferably, the process unit is arranged on an individual process chip. The process chip is, for example, a field programmable gate array (FPGA). Alternatively, it is possible that the process chip is an ASIC or a microcontroller.

It is also possible that the process unit is arranged on the second electronic chip or on the common electronic chip. This allows for a higher rate of integration.

According to at least one embodiment of the detection module, the detection module comprises a plurality of silicon drift detectors and a plurality of evaluation units, wherein each silicon drift detector is assigned to exactly one evaluation unit.

For example, all evaluation units comprise the same regions of interest. In this case, the precision of a total output signal may be increased due to averaging a plurality of individual output signals from each evaluation unit.

It is also possible that different evaluation units comprise different regions of interest. In this case, a plurality of evaluation units allows for a simultaneous evaluation of a plurality of regions of interest. In particular, if a large number of regions of interest is present, for example more than 8 or more than 32 or more than 128 regions of interest, an evaluation of the regions of interest can be carried out significantly faster.

According to at least one embodiment of the detection module, the evaluation units are connected to each other and are configured to receive a reset signal via a common data line. This reduces the wiring of the detection module.

Alternatively, each evaluation unit is addressed by an individual data line. This allows flexible control of the evaluation units. For example, individual integration units can be reset independently from other integration units. This can be advantageous, for example, if a certain integration unit has to be reset but other integration units can still integrate detector signals.

According to at least one embodiment of the detection module, the comparator unit comprises N comparators and is configured to compare the height of each shaped peak to N upper interest level levels defining N regions of interest. Preferably, N is a natural number greater than one or greater than two.

According to at least one embodiment of the detection module, the comparator unit comprises 2N comparators and is configured to compare the height of each shaped peak to N lower interest level and N upper interest levels defining N regions of interest. Preferably, N is a natural number greater than one or greater than two. For example, N of the 2N comparators are configured to compare each shaped peak with the N lower interest levels and the other N of the 2N comparators are configured to compare each shaped peak with the corresponding N upper interest levels.

Furthermore, a sorting machine is specified. In particular, the sorting machine is configured to carry out the method for processing a detector signal described herein according to one or more embodiments. Furthermore, the sorting machine preferably comprises a detection module described herein according to one or more embodiments. That is, all features disclosed for the method and the detection module are also disclosed for the sorting machine and vice versa.

According to at least one embodiment, the sorting machine comprises a conveyer band configured to transport the material to be sorted. Furthermore, the sorting machine comprises an X-ray source configured to radiate a part of the conveyer band. The sorting machine further comprises a detection module according to one or more of the embodiments described herein. The detection module is configured to at least partially detect a material composition of the material to be sorted passing the X-ray source via X-ray fluorescence (XRF). Furthermore, the sorting machine comprises a sorting device configured to sort the material based on the material composition.

In particular, the sorting machine is configured to sort materials based on their material composition. For example, the material passes the X-ray source on the conveyer band. In the part of the conveyer band that is radiated by the X-ray source, the material is exposed to X-rays and the detection module detects radiation from the material emerging as a reaction to the exposure to the X-rays. That is, the material is analyzed by means of XRF. The corresponding XRF-spectrum of the material comprises characteristic lines for the composition of the material. The regions of interest of the detection module are preferably adapted to the characteristic lines of the material of interest. If the radiation is emerging from the material on the conveyer band, the material of interest is included in the material on the conveyer band. The sorting device eventually sorts the material such that the parts of the material that do not show the characteristic lines are removed or vice versa.

The material may be ores or the like. The ore may be analyzed by the sorting machine with respect to its material composition, and ore that does not comprise a desired material or metal may be removed.

By carrying out the method described herein for processing a detector signal, only certain regions of interest of the radiation emerging from the material on the conveyer band have to be analyzed. Since these regions preferably represent the characteristic lines, it is sufficient to analyze only the regions of interest. Hence, it is not necessary to generate a whole XRF spectrum. Therefore, the sorting of the material can be carried out in a cheaper and faster way.

### BRIEF DESCRIPTION OF THE DRAWINGS

Further advantages and advantageous embodiments and further developments of the method for processing a detector signal, the detection module and the sorting machine described herein will become apparent from the following exemplary embodiments shown in connection with schematic drawings. Identical elements, elements of the same kind or elements having the same effect are provided with the same reference signs in the figures. The figures and the proportions of the elements shown in the figures are not to be regarded as true to scale. Rather, individual elements may be shown exageratedly large for better representability and/or for better comprehensibility.

In the figures:

FIG. 1 shows a block diagram of a method for processing a detector signal described herein according to an exemplary embodiment;

FIG. 2-7 illustrate different signals that are generated during the method for processing a detector signal according to the exemplary embodiment;

FIGS. 8-14 illustrate a detection module described herein according to different exemplary embodiments; AND

FIG. 15 illustrates a sorting machine described herein according to an exemplary embodiment.

### DETAILED DESCRIPTION OF ILLUSTRATIVE EMBODIMENTS

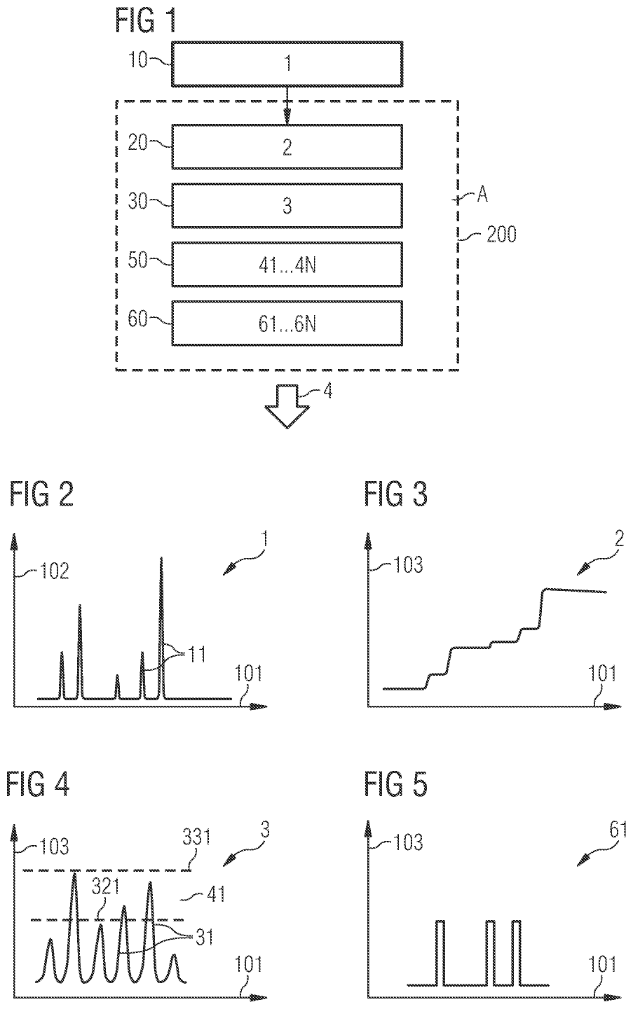

FIG. 1 illustrates the method for processing a detector signal according to an exemplary embodiment. The detector signal 1 is provided by a processor unit 10. The processor unit 10 may comprise at least one silicon drift detector. The detector unit 10 is configured to detect electromagnetic radiation, in particular X-rays. For each X-ray photon that is detected by the detector unit 10, the detector signal 1 comprises a signal peak 11 (cf. FIG. 2). The signal peak 11 comprises 100 to 100,000 electrons, depending on the energy of the detector photon, resulting in a current 102. The detector signal 1 comprises a sequence of signal peaks 11 over time 101. An area of each signal peak 11 corresponds to the energy of the photon.

The detector signal 1 is provided to an integration unit 20, which is configured to generate an integrated signal 2 of the detector signal 1. The integration unit 20 is a charge-sensitive-amplifier comprising an input transistor and a feedback capacitor between input and output. Charges are accumulated at the feedback capacitor. That is, every time 101 a signal peak 11 is fed into the input of the integration unit 20, its charges are generating a voltage rise 103 at the output so that the output signal 2 is proportional to the detector signal 1.

The integrated signal 2 is a continuous ramped signal comprising a plurality of steps (cf. FIG. 3). Each step corresponds to a signal peak 11 of the detector signal 1. In particular, a step height of each step corresponds to the area of the associated signal peak 11 and therefore to the energy of the corresponding photon detected by the detection unit 10.

In a next step of the method, a shaped signal 3 is generated from the integrated signal 2 by a shaping unit 30. The shaped signal 3 comprises a sequence of shaped peaks 31. Each shaped peak 31 is a Gaussian or approximately a Gaussian or a quasi-Gaussian (cf. FIG. 4). Each shaped peak 31 corresponds to a step of the integrated signal 2. The height of each shaped peak 31 corresponds to the step height of the associated step. That is, the height of each shaped peak 31 corresponds to the energy of the associated detected photon.

In a next method step, the shaped peaks 31 are binned at least one region of interest 41 . . . 4N by means of a comparator unit 50. By the comparator unit 50 each shaped peak 31 is compared to at least one upper interest level 331 and optionally to at least one lower interest level 321, which define the at least one region of interest 41 . . . 4N.

For example, if a shaped peak is below the voltage 103 of an upper interest level 331, the shaped peak is assigned to this upper interest level 331. The upper interest level 331 and an adjacent other upper interest level 332 define the reason of interest 41. By comparing the peaks assigned to the upper interest level 331 and the other upper interest level 332, the peas may be binned in the regions of interest 41. That is, if a shaped peak is assigned to the upper interest level 331 but not to the other upper interest level 332 because its height is above the other interest level 332, the peaks is binned in the region of interest 41 defined by the upper interest level 331 and the other upper interest level 332.

Alternatively, if a shaped peak 31 is above the voltage 103 of the lower interest level 321 and below the voltage 103 of the upper interest level 331, this shaped peak 31 is binned in the corresponding region of interest 41, for example (cf. FIG. 4). Comparison to the lower/upper level of interest 321, 331 is carried out by two comparators.

A counter unit 60 increases at least one number of counts 61 . . . 6N for each region of interest 41 . . . 4N for each shaped peak 31 that is binned in the corresponding region of interest 41 . . . 4N. In the exemplary embodiment of FIGS. 1 to 5, the number of counts 61 of the region of interest 41 is increased every time a shaped peak 31 is above the lower interest level 321 and below the upper interest level 331. In the sequence shown in FIG. 4, the number of counts is consequently 3 (cf. FIG. 5).

That is, the detector signal 1 can be digitized by the method for processing a detector signal 1. The steps of processing the detector signal to the number of counts are thus a digitization step A. During the digitization step A the method is free of a clock signal 6. Such clock signals 6 in general may interfere with the signal processing by applying some noise. By the method described herein, the clock signal 6 is not necessary for digitization. Hence, noise in the method can be reduced.

The digitization step A is carried out on a common electronic chip 200. That is, the integration unit 20, the shaping unit 30, the comparator unit 50 and the counter unit 60 are arranged on a common electronic chip 200. The electronic chip 200 may be an ASIC.

If a large number of regions of interest 41 . . . 4N is chosen, information about a plurality of photon energies can be obtained. However, in many applications it is not necessary to reconstruct a full spectrum, but detection of individual photon energies emerging from a probe is sufficient. For example, only characteristic peaks of a material to be detected are sufficient to verify the presence of the material during XRF. Therefore, the region of interests 41 . . . 4N may be adapted to cover characteristic peaks of the material. Thus, the number of data to be collected can be significantly reduced compared to a full spectrum.

In a transferring step B the number of counts 61 . . . 6N are provided as an output signal 4. In the transferring step B a clock signal 6 may be provided.

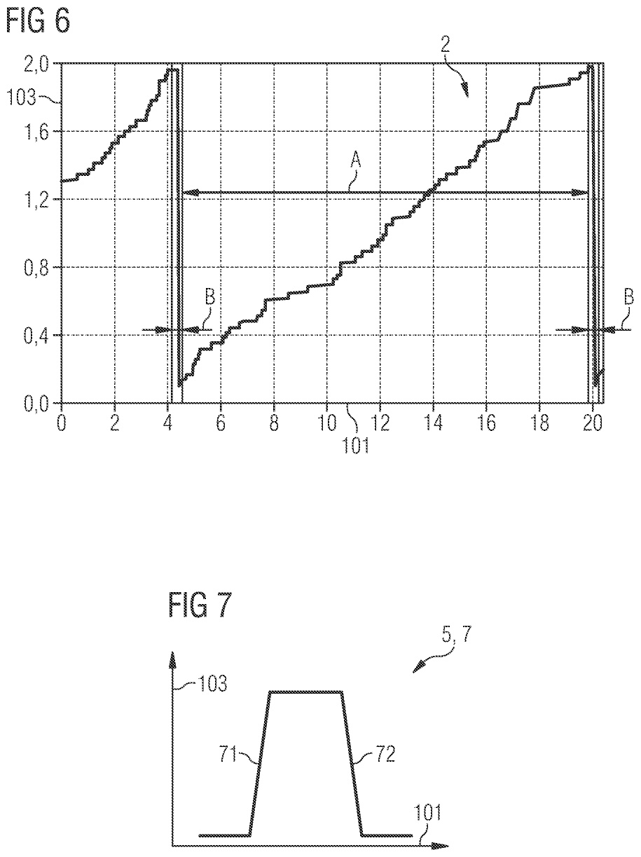

Since in the integration unit 20 charges are cumulated, the charge may have to be reset in order to prevent the amplifier from leaving the operation range. Resetting the integration unit 20 is carried out during the transferring step B. This brings the integrated signal 2 to zero or essentially zero (cf. FIG. 6).

Resetting the integration unit 20 is triggered by a reset signal 5, which comprises a reset pulse 7 (cf. FIG. 7). The reset signal 5 is provided for a time 101, i.e. a reset time. The reset signal 5 comprises a rising edge 71 and a falling edge 72.

The rising edge 71 starts resetting the integration unit 20. Furthermore, the rising edge 71 starts providing the output signal 4. Moreover, the rising edge 71 terminates a counting by the counting unit 60. That is, the rising edge 71 terminates the digitization step A and starts the transferring step B.

The falling edge 72 in turn starts the counting of the counting unit 60. Furthermore, the falling edge 72 may start integration of the detector signal 1 by the integration unit 20. Moreover, the falling edge 72 may terminate the provision of the output signal 4. That is, the falling edge 72 terminates the transferring step B and starts the digitization step A.

In another exemplary embodiment a falling edge 72 starts resetting the integration unit 20. Furthermore, this falling edge 72 starts providing the output signal 4. Moreover, this falling edge 72 terminates a counting by the counting unit 60. In turn, a rising edge 71 starts the counting of the counting unit 60. Furthermore, this rising edge 71 may start integration of the detector signal 1 by the integration unit 20. Moreover, this rising edge 71 may terminate the provision of the output signal 4

The reset time is determined by the longer one of the period for resetting the integration unit 20 and the period for completely providing the output signal 4. The clock signal 6 is provided during the reset time, i.e., during the reset pulse 7.

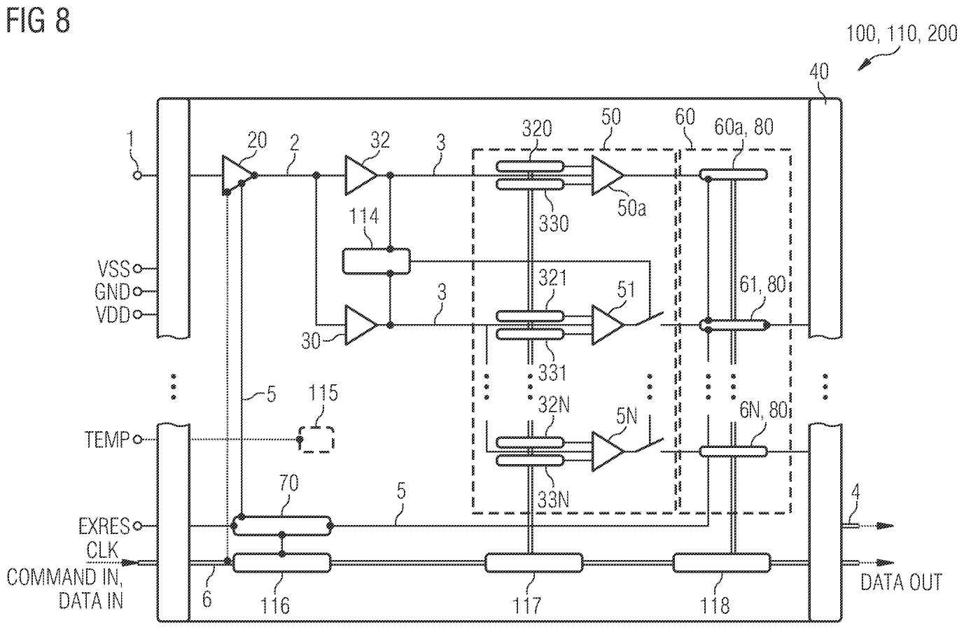

FIG. 8 shows a block diagram of a detection module 100 described herein according to an exemplary embodiment. The detection module 100 comprises an integration unit 20 configured to process the detector signal 1 to an integrated signal 2. The integration unit 20 is a charge-sensitive amplifier.

An output of the integration unit 20 is connected to a shaping unit 30 and a further shaping unit 32. The shaping units 30, 32 are configured to form a shaped signal 3 from the integrated signal 2 as described above (cf. FIG. 4). The shaping unit 30 and the further shaping unit 32 differ in shaping time. In particular, the further shaping unit 32 is a fast shaping unit 32 with a shaping time of about 25 ns. The shaping unit 30 comprises a shaping time of about 350 ns, for example.

The signal of the fast-shaping unit 32 is used to evaluate the total incoming count rate as well as to control a pile-up rejection unit 114. The pile-up rejection unit 114 is disabling the output of comparator units 51, 52, 5N in case of two or more overlapping detection events. An overlapping detection event in particular occurs it two or more photons are detected in a short period of time. In this case, signal peaks of these two detection events overlap and an area of the signal peak cannot be assigned to a photon energy. Hence, overlapping events are falsifying the result. The signal of the regular shaping unit 30 is processed with the comparator unit 50 and sorted into the different regions of interest when indicated.

In some embodiments of the invention, depending on the amplifier configuration a baseline holder or a pole zero cancellation might be advantageous to keep the output baseline close and stable to zero.

Outputs of the shaping units 30, 32 are connected to a comparator unit 50. The comparator unit 50 comprises a plurality of comparators 51 . . . 5N, which are configured to bin the shaped peaks 31 in a plurality of regions of interest 41 . . . 4N. This is achieved by comparing each shaped peak 31 with N lower interest levels 321 . . . 32N and N upper interest levels 331 . . . 33N by means of the 2N comparators 51 . . . 5N. The lower interest levels 321 . . . 32N and upper interest levels 331 . . . 33N may be stored in an interest level register 117. If a height of a shaped peak 31 is between a specific lower interest level 321 and a corresponding upper interest level 331, the shaped peak 31 is binned in the corresponding region of interest 41 defined by the lower interest level 321 and the upper interest level 331.

Outputs of the comparator unit 50 are connected to a counter unit 60, which is configured to increase a plurality number of counts 61 . . . 6N. Each number of counts 61 . . . 6N corresponds to a region of interest 41 . . . 4N. Every time a shaped peak 31 is binned in a certain region of interest 41 . . . 4N, the associated number of counts 41 . . . 4N is increased. The number of counts 41 . . . 4N are stored in a storage unit 80. The storage unit 80 is, for example, a shift register.

Furthermore, the comparator unit 50 comprises a total comparator 50a configured to determine a total number of counts 60a. To achieve this the shaped peaks generated by the past shaper 32 are compared to a total upper interest level 320 and a total lower interest level 330 defining the total detection range.

Outputs of the counter unit 60 are connected to an output unit 40, which is configured to provide the number of counts 61 . . . 6N as an output signal 4.

The detection module 100 may further optionally comprise a temperature unit 115 with at least one temperature sensor. The temperature unit 115 is configured to monitor and control the temperature of the detection module 100. For example, it may be advantageous to cool the detection module 100 or parts of the detection module 100 to reduce thermal noise.

The detection module 100 further comprises a reset logic 70, which is configured to provide a reset signal 5. The reset signal 5 is configured to reset the integration unit 20, as described in connection with FIGS. 6 and 7. Therefore, the reset logic 70 is connected to the integration unit 20. Furthermore, the reset logic 70 is configured to start and terminate counting of the counting unit 60. Therefore, the reset logic 70 is connected to the counter unit 60. The reset logic 70 is further configured to check both if the reset of the integration unit 20 is complete and if the transferring step B is complete.

The detection module 100 further comprises a command register 116. The command register 116 is configured to control the detection module, in particular the integration unit 20.

Furthermore, the detection module 100 comprises a counter enable register 118 configured to control the counter unit 60.

The detection module 100 is formed on a common electronic chip 200. The electronic chip 200 is, for example, an ASIC. As an input, the electronic chip 200 comprises a line for receiving the detector signal 1; a voltage supply VSS, GND, VDD; an external reset line EXRES; an external clock CLK for providing a clock signal 6; a data input line DATA IN for providing data to the detection module, for example the lower/upper interest levels 321 . . . 321N, 331 . . . 33N; and a command input line COMMAND IN for controlling the electronic chip 200. As an output, the electronic chip 200 comprises a line for providing the output signal 4 and a data output line DATA OUT. Optionally, the electronic chip 200 may comprise a temperature line TEMP, if the detection unit 100 comprises a temperature unit 115.

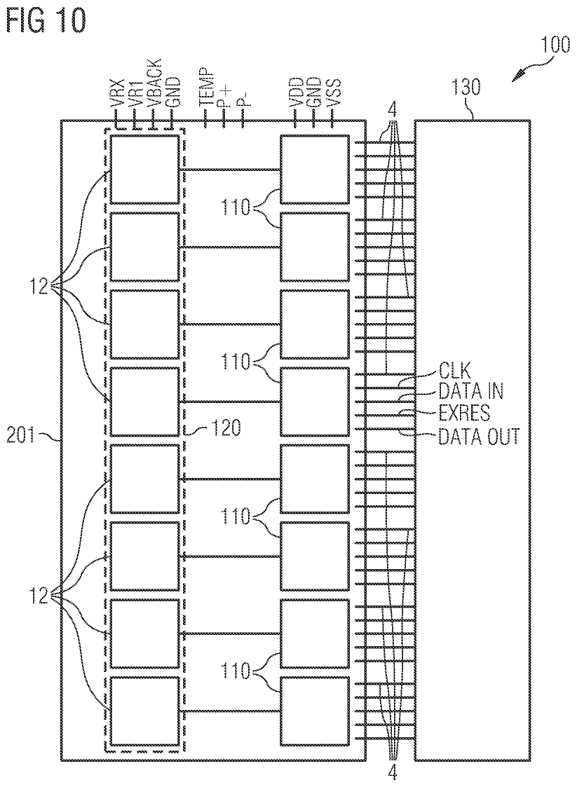

The detection module 100 may comprise an evaluation unit 110, configured to process the detector signal. In particular, FIG. 8 shows the evaluation unit 110. The detection module 100 may further comprise a detector unit 120, as illustrated by FIG. 10. The detector unit 120 may comprise a plurality of silicon drift detectors 12.

In FIG. 10, each silicon drift detector is connected to an evaluation unit 110. In particular, each evaluation unit 110 is an evaluation unit as illustrated in FIG. 8.

The detector unit 120 comprises a voltage supply VRX, VR1, VBACK, GND for the silicon drift detector chips. The detection module 100 may further comprise a temperature line TEMP and two lines P+, P− for the thermoelectric cooling (TEC) unit comprising the temperature unit 115.

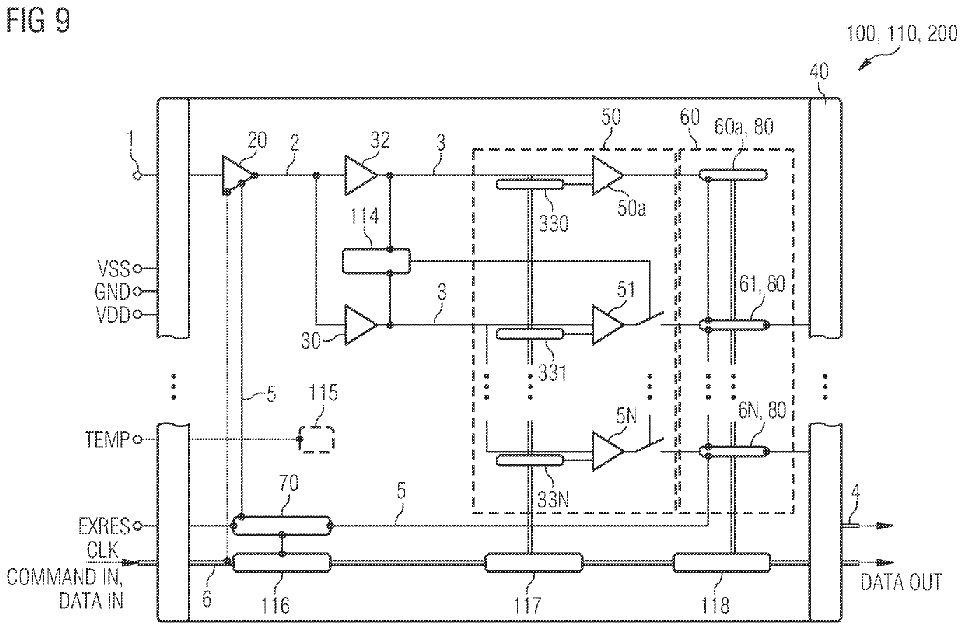

FIG. 9 illustrates an exemplary embodiment comprising essentially the same features as the exemplary embodiment shown in FIG. 8 differing in that the comparator unit 50 comprises N comparators 51 . . . 5N. Each comparator 51 . . . 5N is defined to compare the height of the shaped peaks 31 of the shaped signal 3 to an upper interest level 331 . . . 33N. Thereby, two adjacent upper interest levels 331 . . . 33N define a region of interest 41 . . . 4N. By comparing the shaped peaks 31 assigned to each upper interest level 331 . . . 33N from the shaped peaks 31 assigned to an adjacent upper interest level 331 . . . 33N allows for binning the peaks in N regions of interest 41 . . . 4N with providing only N comparators.

According to the exemplary embodiment of FIG. 10, the detection module 100 further comprises a processing unit 130. The processing unit 130 is, for example, configured to control the evaluation unit 110 and the detector unit 120. Furthermore, the processing unit 130 is configured to receive the output signal 4 for further processing.

The processing unit 130 is connected to each evaluation unit 110 by a line for the output signal 4; a clock CLK; a data input line DATA IN; an external reset line EXRES; and a data output line CMD IN. The data input line DATA IN may also be configured to transfer command data. That is, each evaluation unit 110 can be essentially controlled independently from other evaluation units 110.

The detector unit 120 and the evaluation units 110 are arranged in a common electronic package 201. The processor unit 130 is arranged on an individual electronic chip that is preferably a FPGA.

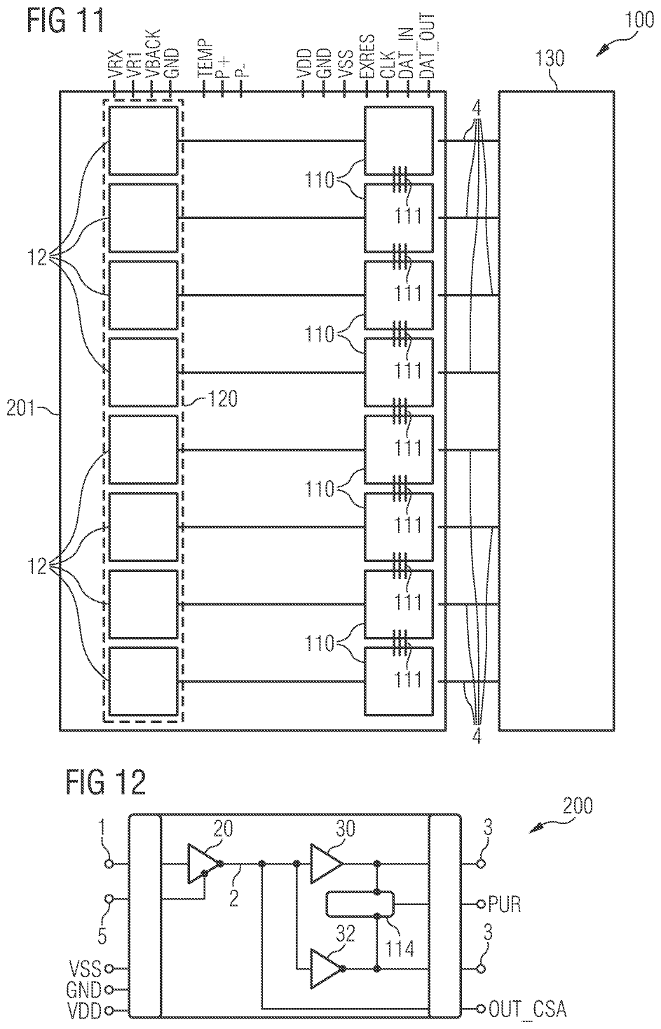

FIG. 11 shows a detection module 100 described herein according to an exemplary embodiment. In contrast to the detection module 100 of FIG. 10, the detection module 100 according to FIG. 11 comprises a common input for the clock CLK, the external reset line EXRES, the data input line DATA IN and the data output line DATA OUT for all evaluation units 110. The evaluation units 110 are connected by a data line 111 to distribute signals from the common input to all evaluation units 110. Each evaluation unit 110 is connected to the processor unit 130 in order to provide the output signal 4. By this configuration, wiring of the detection module 100 can be simplified.

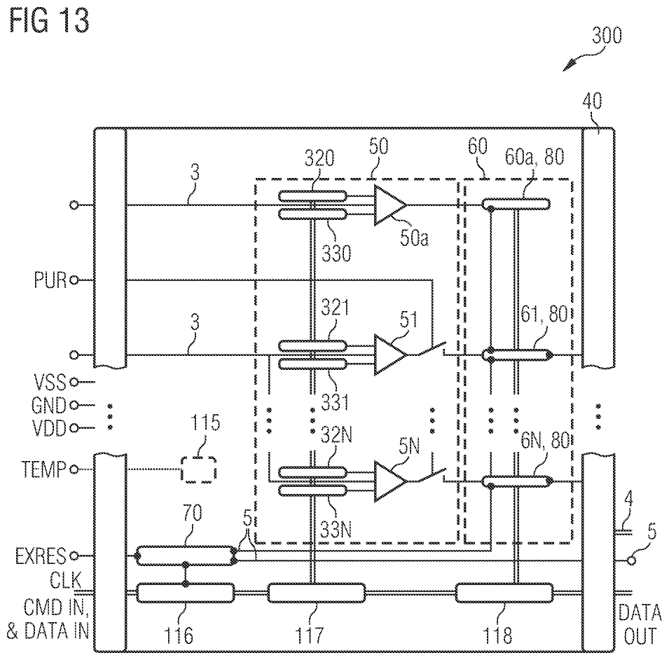

FIGS. 12 and 13 illustrate a detection module according to a further exemplary embodiment. In contrast to the exemplary embodiment of FIG. 8, the integration unit 20 and the shaping unit 30, as well as the optional pole zero cancellation unit 112, the baseline holder unit 113 and the pileup rejection unit 114 are arranged on a first electronic chip 200. The first electronic chip 200 is, for example, an ASIC.

Other components of the evaluation unit 110, in particular the comparator unit 50 and the counter unit 60, are arranged on a second electronic chip 300, which may also be an ASIC.

For example, the first and second electronic chip 200, 300 differ in the manufacturing technology. That is, the first electronic chip 200 may be formed with so-called 350 nm technology and the second electronic chip 300 may be formed with so-called 150 nm technology.

The first electronic chip 200 comprises a line for the detector signal 3, a line for the reset signal 5, and a voltage supply VSS, VDD, GND as inputs. As outputs the first electronic chip 200 comprises lines for the shaped signal 3, an output line of the integration unit OUT_CSA and a line for the pileup rejection unit PUR.

The outputs of the first electronic chip 200 are provided as inputs to the second electronic chip 300. Furthermore, the second electronic chip 300 comprises a voltage supply VSS, VDD, GND, an external reset line EXRES, a clock CLK, a data input line DATA IN and a command input line CMD IN as inputs. Optionally, the second electronic chip 300 comprises a temperature line TEMP. As outputs, the second electronic chip 300 comprises a line for the output signal 4, a line for the reset signal 5 that may be input to the first electronic chip, and a data output line DATA OUT.

In other aspects, in particular in its functionality and technical effects, the detection module 100 according to the exemplary embodiments of FIGS. 12 and 13 comprises essentially the same features as the exemplary embodiment according to FIG. 8. It is further possible that the comparator unit 50 is formed as described in connection with the exemplary embodiment of FIG. 9.

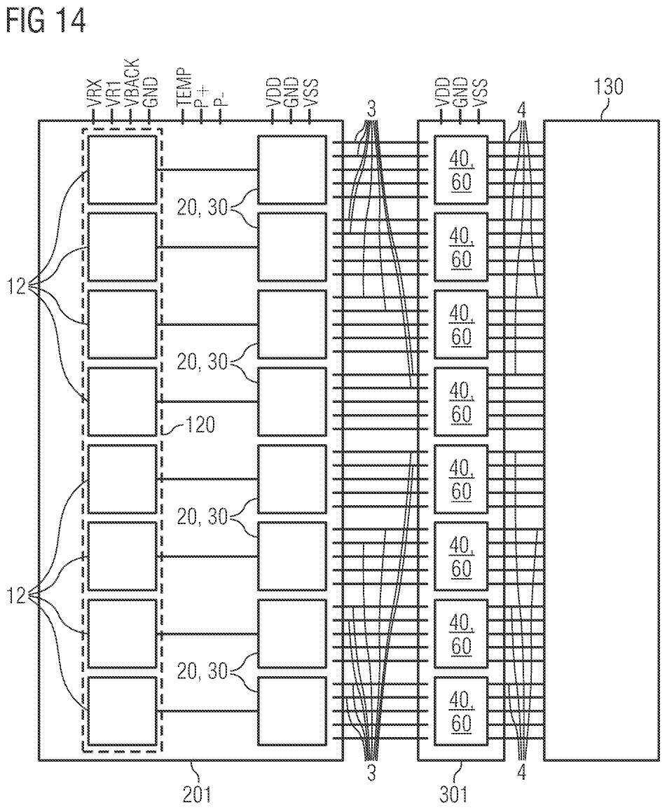

FIG. 14 shows the detection module 100 according to an exemplary embodiment. In contrast to FIG. 10, the detection module comprises a first electronic package 201 and a second electronic package 301. In the first electronic package 201, a plurality of integration units 20 and shaping units 30 are arranged together with a detector unit 120 with a plurality of silicon drift detectors 12. In the second electronic package 301, a plurality of counter units 60 and output units 40 are arranged. A connection between the first and second electronic packages 201, 301 is, for example, as described in connection with FIGS. 12 and 13.

The second electronic package 301 is connected to a processor unit 130. The processor unit 130 and the connecting lines between the processor unit 130 and the second electronic chip 300 comprise the same features as the processor unit 130 and the connecting lines according to FIG. 10.

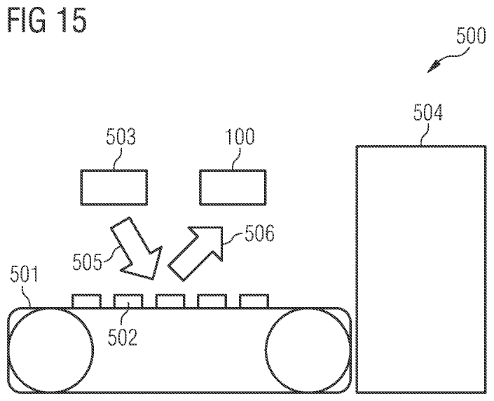

FIG. 15 illustrates a sorting machine 500 described herein according to an exemplary embodiment. The sorting machine 500 comprises a conveyer band 501 on which material to be sorted 502 is arranged. The material to be sorted 502 is illuminated with X-rays 505 by an X-ray source 503 during operation. The X-ray source 503 is, for example, an X-ray tube.

The sorting machine 500 further comprises a detection module 100 according to an exemplary embodiment described above. X-rays that emerge from the material 506 are detected by the detection module 100. By means of XRF, a material composition of the material 502 can be obtained. A sorting device 504 sorts the material 502 according to its material composition.

For example, some of the material 502 comprises a specific element or molecule or composition. In order to separate the material 502 with the specific composition from the other material, the material composition of the material is analyzed by XRF.

In particular, regions of interest 41 . . . 4N of the detection module are adapted to characteristic lines or peaks of the specific element or molecule or composition. Hence, it is not necessary to generate a whole CRF spectrum. Therefore, the sorting of the material 502 can be carried out cheaper and faster.

By the detection module 100, the specific composition is detected and the sorting device 504 separates the material 502 with the specific composition from the other material.

The material may comprise ores or the like. By the sorting machine 500, the ore may be analyzed with respect to its material composition: ore comprising a desired material or metal under or above a certain level may be removed.

The invention is not restricted to the exemplary embodiments of the description on the basis of said exemplary embodiments. Rather, the invention encompasses any new feature and also any combination of features which in particular comprises any combination of features in the patent claims and any combination of features in the exemplary embodiments, even if this feature or this combination itself is not explicitly specified in the patent claims or exemplary embodiments.

What is claimed is:

1. A method for processing a detector signal comprising a sequence of signal peaks, the method comprising:
a digitization step and a transferring step,
wherein, in the digitization step,
the detector signal is processed and binned in at least one region of interest depending on an area of the signal peaks, and
at least one number of counts is determined by a counter, wherein the number of counts corresponds to a number of signal peaks in the region of interest; and
wherein, in the transferring step, the numbers of counts is provided as an output signal, and
wherein during the digitization step the method is free of a clock signal.

2. The method according to claim 1, wherein the clock signal is provided exclusively during the transferring step.

3. The method according to claim 1, wherein, in the transferring step, a reset signal is provided such that during provision of the reset signal, the counter is terminated and the output signal is provided.

4. The method according to claim 3, wherein the reset signal is provided for a reset time, and wherein the reset time is determined by a period for resetting an integration unit or by a period for providing the output signal.

5. The method according to claim 3, wherein the reset signal comprises at least one reset pulse, wherein a rising or falling edge of the reset pulse terminates the counter and activates resetting of an integration unit, and wherein a falling or rising edge of the reset pulse actives the counter and terminates resetting of the integration unit.

6. The method according to claim 1,
wherein, in the digitization step, the detector signal is integrated by an integration unit, and
wherein, in the transferring step, the integration unit is reset such that a cumulated signal at an input of the integration unit is set to zero or essentially zero.

7. The method according to claim 1,
wherein, in the digitization step,
the detector signal is processed to an integrated signal by integrating the detector signal by an integration unit,
the integrated signal is processed to a shaped signal comprising a plurality of shaped peaks by a shaping unit,
the shaped signal is binned in at least one region of interest depending on a height of the shaped peaks by comparing the height of each of the shaped peaks to at least one upper interest level defining the region of interest by a comparator, and
the number of counts corresponding to the region of interest is increased for every shaped peak whose height is in the region of interest by the counter.

8. The method according to claim 7,
wherein the integrated signal comprises a plurality of steps,
wherein each step corresponds to a signal peak of the detection signal, and
wherein a height of each step corresponds to an area of the corresponding signal peak.

9. The method according to claim 1, wherein, in the digitization step,
the detector signal is processed to an integrated signal by integrating the detector signal by an integration unit,
the integrated signal is processed to a shaped signal comprising a plurality of shaped peaks by a shaping unit,
the shaped signal is binned in at least one region of interest depending on a height of the shaped peaks by comparing the height of each of the shaped peaks to at least one upper interest level and at least one lower interest level defining the region of interest by a comparator, and
the number of counts corresponding to the region of interest is increased for every shaped peak whose height is in the region of interest by the counter.

10. The method according to claim 1, wherein the detector signal is provided by at least one silicon drift detector.

11. A detection module comprising:
an evaluation unit comprising:
an integration unit configured to process a detection signal, comprising a plurality of signal peaks, to an integrated signal by integrating the detection signal;
a shaping unit configured to process the integrated signal to a shaped signal comprising a plurality of shaped peaks;
a comparator configured to compare a height of each of the shaped peaks to at least two upper interest level defining at least one region of interest;
a counter configured to increase a number of counts corresponding to the region of interest for every shaped peak whose height is in the region of interest;
a storage configured to store the number of counts of the region of interest; and
an output configured to output the number of counts as an output signal.

12. The detection module according to claim 11 further comprising a reset logic configured check both whether a reset of the integration unit is complete and whether a transferring is complete.

13. The detection module according to claim 11, wherein the integration unit and the shaping unit are arranged on a first electronic chip and the comparator, the counter and the storage are arranged on a second electronic chip distinct from the first electronic chip.

14. The detection module according to claim 11, wherein at least the integration unit, the shaping unit, the comparator, the counter and the storage are arranged on a common electronic chip.

15. The detection module according to claim 11, further comprising:
a detector unit configured to generate a detector signal from detected electromagnetic radiation, and
a processor configured to process the output signal and to control the detection module
wherein the detector unit comprises at least one silicon drift detector.

16. The detection module according to claim 15, further comprising a plurality of silicon drift detectors and a plurality of evaluation units, wherein each silicon drift detector is assigned to exactly one evaluation unit.

17. The detection module according to claim 16, wherein the evaluation units are connected to each other and are configured to receive a reset signal via a common data line.

18. The detection module according to claim 11, wherein the comparator comprises N comparators and is configured to compare the height of each shaped peak to N upper interest levels defining N regions of interest, and wherein N is a natural number greater than two.

19. The detection module according to claim 11, wherein the comparator comprises 2N comparators and is configured to compare the height of each shaped peak to N lower interest level and N upper interest levels defining N regions of interest, and wherein N is a natural number greater than two.

20. A sorting machine comprising:
a conveyer band configured to transport a material to be sorted;
an X-ray source configured to radiate a part of the conveyer band;
the detection module according to claim 11, the detection module configured to at least partially detect a material composition of the material to be sorted passing the X-ray source via X-ray fluorescence spectroscopy; and
a sorting device configured to sort the material based on the material composition.
